(19) United States
(12) Patent Application Publication
(10) Pub. No.: US 2010/0309065 A1
(43) Pub. Date: Dec. 9, 2010

(54) ARRANGEMENT AND METHOD, PARTICULARLY FOR A MOTOR VEHICLE WINDSHIELD ANTENNA FOR INFLUENCING THE DIRECTIONAL EFFECT

(76) Inventor: Rainer Kuehne, Hannover (DE)

Correspondence Address: KENYON & KENYON LLP, ONE BROADWAY, NEW YORK, NY, 10004, US

(21) Appl. No.: 12/744,632

(22) PCT Filed: Oct. 10, 2008
(86) PCT No.: PCT/EP08/63601

§ 371 Date: Jul. 23, 2010

(30) Foreign Application Priority Data
Nov. 26, 2007 (DE) 102007056911.6

(51) Int. Cl. H01Q 1/50; H01Q 1/32; H01Q 1/02

(52) U.S. Cl. 343/704; 343/713; 343/850

(57) ABSTRACT

An antenna arrangement is described, and is made up of a VHF antenna conductor structure and a separate LMS antenna conductor structure, the connection of an impedance network for influencing the directivity for VHF reception occurs via the LMS antenna conductor structure that is coupled to the VHF antenna conductor structure at high frequency.

### FIELD OF THE INVENTION

The present invention is based on an antenna arrangement and a method relating thereto.

### BACKGROUND INFORMATION

An antenna arrangement is discussed in U.S. Pat. No. 6,307,516 B1. There the heating field is used as an antenna for receiving VHF signals (FM signals). Between the upper edge of the motor vehicle window pane and the heating field there is a separate conductor structure, not galvanically connected to the heating field, as an antenna for receiving LMS signals (AM signals).

Diversity antenna systems for VHF signals are also discussed in patent documents EP 1 076 375 A2 and DE 44 08 744 A1, in which additional impedances are connected at a first location of the heating field. By connecting an impedance at the first location, the antenna impedance at a second location of the heating field, at the base point of an FM antenna that is tapped on the heating field, is changed in such a way that a different directivity characteristic is produced and thus diversity radio reception is ensured. The connection of the impedance is controlled by a known diversity logic circuit that recognizes whether there is an interference in the reception. This system produces a virtual dual-antenna system having only one physical antenna base. If the heating field is at the same time used as an LMS antenna, filter elements are required for the purpose of decoupling the vehicle electrical system.

### SUMMARY OF THE INVENTION

The antenna arrangement or the method of the present invention allows for the connection of an impedance network and thus for changing the directivity characteristic of a VHF antenna without additional contact points on the heating field or on the LMS conductor structure. The antenna connection point for the LMS conductor structure, which is present in any event, is also used as the connection point for the impedance network. It is possible to omit additional cost-intensive and corrosion-susceptible high-frequency contacts on the motor vehicle window pane for connecting the impedance network as well as additional conductor structures on or in the window pane.

Another special advantage of the exemplary embodiments and/or exemplary methods of the present invention is that no special filter elements are required for decoupling the LMS antenna function from the vehicle electrical system interferences in the form of a current-compensated toroidal core inductor (highly resistive high-frequency technology component). An LMS filter element may be omitted since the capacitive coupling between the antenna and the heating field is so low for LMS frequencies that vehicle electrical system interferences do not crosstalk in the heating current. At the same time, the LMS antenna structure may be designed in such a way that the capacitive coupling is sufficiently high for VHF frequencies and that connecting one or more additional impedances to the LMS antenna produces the desired behavior in the base point of the FM antenna.

A low-impedance coupling conductor of a specified length and width attached on the heating field, as in EP 1 076 375 A2 for example, is not required.

The exemplary embodiments and/or exemplary methods of the present invention is suitable for use in a motor vehicle window pane, in particular a rear window, in which the heating field is used as a VHF antenna conductor structure. With the invention, the heating field must be equipped with only one contact for the antenna base point. Additional measures for diversity operation are not required on the heating field.

A conductor loop capacitively coupled to the VHF antenna conductor structure is especially suitable as an LMS antenna conductor structure.

The connection of the impedance network is advantageously controllable using a diversity device for VHF reception via only one control conductor.

For a defined diversity behavior it is advantageous to develop the antenna base point on a conductor of the heating field that is situated at a distance from the LMS antenna conductor structure.

In particular it is advantageous to run the conductor loop of the LMS conductor structure in parallel to at least one conductor of the heating field that is not a component of a low-impedance bus bar so as to achieve a good HF coupling to the heating field.

In the case of VHF reception, an arrangement is advantageously provided to separate the LMS antenna conductor structure from the LMS receiving unit. Thus there is no interference or mismatch and an associated signal deterioration.

Exemplary embodiments of the present invention are shown in the drawing and are explained in greater detail in the following description.

### DESCRIPTION OF THE DRAWINGS

FIG. 1 shows a block diagram for an antenna arrangement according to the present invention.

FIG. 2 shows an embodiment of the impedance network.

### DETAILED DESCRIPTION

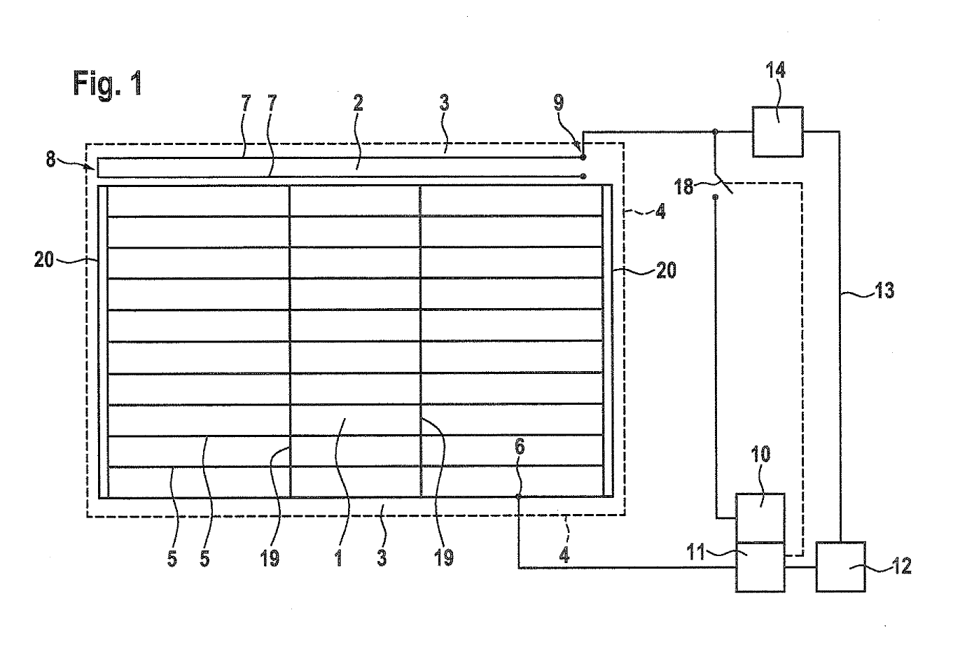

The antenna conductor structure 1 for VHF reception and the antenna conductor structure 2 for LMS reception as shown in FIG. 1 are applied on a window pane 3 by common methods, it being unimportant in the sense of the exemplary embodiments and/or exemplary methods of the present invention whether this is a single pane safety glass or a multilayer safety glass. Window pane 3 is surrounded by a metal frame 4 and developed e.g. as the rear window of a motor vehicle.

Antenna conductor structure 1 for VHF reception is formed by the heating field. The latter is made up of heating wires 5 running in parallel in the horizontal direction and vertical bus bars 20, into which the heating current is fed. Antenna base point 6 for VHF reception is connected to the lowermost heating wire 5. Antenna conductor structure 2 for LMS reception is made up of a separate conductor loop, which is not galvanically connected to the heating field and which is situated between heating field 6 and the upper edge of window 3. The galvanic decoupling yields the advantage that no complex interference suppression components are required for filtering the vehicle electrical system. The conductor loop is made up of two horizontal parallel conductors 7 and one vertical connecting conductor 8. Conductors 7 thus run also parallel to heating wires 5.

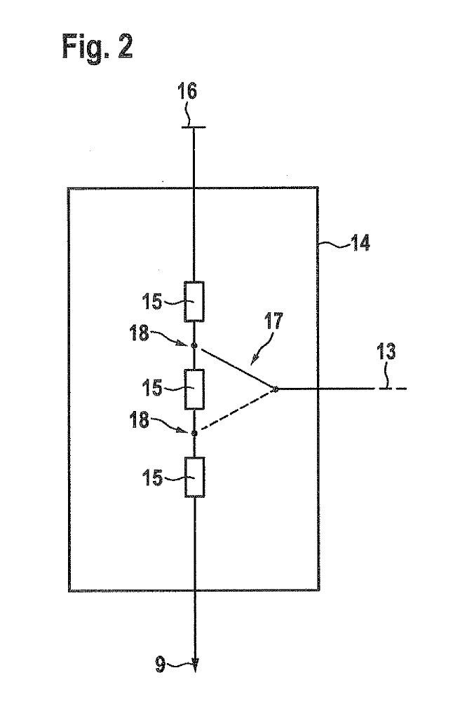

Antenna base point 9 of antenna conductor structure 2 for LMS reception is connected to receiver unit 10 for LMS reception (AM signals). Antenna base point 6 of antenna conductor structure 1 for VHF reception is connected to receiver unit 11 for VHF reception (FM signals). The latter receiver unit 11 has a common diversity device 12 assigned to it. Diversity device 12 monitors the signal strength in VHF reception. If it gets too weak or experiences interference, an impedance network 14 is connected to antenna structure 1 via control conductor 13 in order to change the directivity characteristic and to ensure once again interference-free VHF reception. This connection of impedance network 14 is not direct, but in accordance with the exemplary embodiments and/or exemplary methods of the present invention occurs via LMS conductor structure 2, which is coupled at high frequency to VHF antenna conductor structure 1. By the layout of LMS antenna conductor structure 2—running conductors 7 in parallel to heating wires 5 and taking into account the length of the conductor—it is possible to achieve a high-frequency capacitive coupling that is sufficiently high for VHF frequencies. As shown in FIG. 2, impedance network 14 allows for the connection of one or more impedances 15 between antenna base point 9 and ground 16 or the chassis via selector switch 17 and impedance connection points 18.

For controlling selector switch 17, diversity device 12 may apply different switching signals to control conductor 13. Between base point 6 on the lower end of heating field 1 and connecting point 9 for impedance network 14 situated above heating field 1 at a distance, a sufficient distance results for an effective signal difference and thus for the change of the directivity characteristic of the VHF antenna arrangement.

In VHF-FM reception, LMS receiver unit 10 is separated from LMS antenna conductor structure 2 by switch 18, which may be operated for example from a signal indicator in VHF receiver unit 11.

Via control conductor 13, however, it continues to be possible to connect one or more impedances 15 to LMS antenna conductor structure 2 (point 9). These then effect again a change in the directivity diagram of the VHF antenna in such a way that in the event of an FM signal experiencing interference, an interference-free reception becomes again possible at base point 6 of the VHF antenna.

For improving the reception properties, additional antenna conductors 19 may be provided in heating field 1, which are arranged vertically with respect to heating wires 5 and may be connected to the latter at equipotential points.

1-10. (canceled)

11. An antenna arrangement for a window pane antenna, comprising:
a VHF antenna conductor structure; and
a separate LMS antenna conductor structure;
wherein a connection of an impedance network for influencing a directivity of a VHF reception is provided via the LMS antenna conductor structure which is coupled at high-frequency to the VHF antenna conductor structure.

12. The antenna arrangement of claim 11, wherein the LMS antenna conductor structure is galvanically decoupled from the VHF antenna conductor structure.

13. The antenna arrangement of claim 11, wherein the VHF antenna conductor structure is formed by a heating field of a motor vehicle window pane.

14. The antenna arrangement of claim 11, wherein the LMS antenna conductor structure is made of a conductor loop that is capacitively coupled to the VHF antenna conductor structure.

15. The antenna arrangement of claim 11, wherein the connection of the impedance network is controllable via a diversity device for the VHF reception.

16. The antenna arrangement of claim 13, wherein the antenna base point for the VHF reception is connected to a conductor of the heating field, which is situated at a distance from the LMS antenna conductor structure.

17. The antenna arrangement of claim 14, wherein the conductor loop of the LMS conductor structure runs in parallel to at least one conductor of the heating field, which is not a component of a low-impedance bus bar.

18. The antenna arrangement of claim 11, further comprising:
a separating arrangement to separate the LMS antenna conductor structure from an LMS receiver unit in case of VHF reception.

19. A method for an antenna arrangement for a motor vehicle window pane antenna, the method comprising:
performing a connection of an impedance network for influencing a directivity of a VHF reception via an LMS antenna conductor structure by coupling it at a high-frequency to a VHF antenna conductor structure, wherein the LMS antenna conductor structure is a separate LMS antenna conductor structure from the VHF antenna conductor structure.

20. An antenna arrangement for a motor vehicle window pane antenna, comprising:
a VHF antenna conductor structure; and
a separate LMS antenna conductor structure;
wherein a connection of an impedance network for influencing a directivity of a VHF reception is provided via the LMS antenna conductor structure which is coupled at high-frequency to the VHF antenna conductor structure, and
wherein the antenna conductor structure provides VHS diversity reception in a motor vehicle.

21. The antenna arrangement of claim 11, wherein the window pane antenna is for a motor vehicle.

22. The antenna arrangement of claim 11, wherein the LMS antenna conductor structure is galvanically decoupled from the VHF antenna conductor structure, and wherein the LMS antenna conductor structure is made of a conductor loop that is capacitively coupled to the VHF antenna conductor structure.

23. The method of claim 19, wherein the LMS antenna conductor structure is galvanically decoupled from the VHF antenna conductor structure, and wherein the LMS antenna conductor structure is made of a conductor loop that is capacitively coupled to the VHF antenna conductor structure.
